(19) United States
(12) Patent Application Publication
(10) Pub. No.: US 2001/0005739 A1
(43) Pub. Date: Jun. 28, 2001

(54) GLYCIDYL ETHER ALIPHATIC POLYALCOHOLS AS COUPLING AGENTS IN ANIONIC POLYMERIZATION

(76) Inventors: KONRAD KNOLL, LUDWIGSHAFEN (DE); ALOIS KINDLER, HASSLOCH (DE); WOLFGANG FISCHER, WALLDORF (DE)

Correspondence Address: KEIL & WEINKAUF, 1101 CONNECTICUT AVENUE NW, WASHINGTON, DC, 20036

(21) Appl. No.: 09/445,698

(22) PCT Filed: Jun. 29, 1998
(86) PCT No.: PCT/EP98/03705

§ 371 Date: None

(30) Foreign Application Priority Data
Jun. 30, 1997 (DE) 1972777.05

(51) Int. Cl. C08F 293/00; C08F 4/00; C08F 295/00; C08F 297/00

(52) U.S. Cl. 525/271

(57) ABSTRACT

New oximsulfonate compounds of formulae (I) or (II), wherein m is 0 or 1; x is 1 or 2; R₁ is, for example phenyl, which is unsubstituted or substituted or R₁ is a heteroaryl radical that is unsubstituted or substituted, or, if m is 0, R₁ additionally is C₂-C₆alkoxycarbonyl, phenoxycarbonyl or CN; R′₁ is for example C₂-C₁₂alkylene, phenylene; R₂ has for example one of the meanings of R₁; n is 1 or 2; R₃ is for example C₁-C₁₈alkyl, R′₃ when x is 1, has one of the meanings given for R₃, or R′₃ in formula (IV) and when x is 2 in formula (I), is for example C₂-C₁₂ alkylene, phenylene; R₄ and R₅ are independently of each other for example hydrogen, halogen, C₁-C₆alkyl; R₆ is for example hydrogen, phenyl; R₇ and R₈ are independently of each other for example hydrogen or C₁-C₁₂alkyl; R₉ is for example C₁-C₁₂alkyl; A is S, O, NR₆, or a group of formula (A1), (A2), (A3) or (A4); R₁₀ and R₁₁ independently of each other have one of the meanings given for R₄; R₁₂, R₁₃, R₁₄ and R₁₅ independently of one another are for example hydrogen, C₁-C₄alkyl; Z is CR₁₁ or N; Z₁ is —CH₂—, S, O or NR₆, are useful as latent sulfonic acids, especially in photoresist applications.

The present invention relates to a process for preparing polymers by coupling living polymer blocks formed from an anionic polymerization initiator and anionically polymerizable monomers.

Anionic polymerization produces in the growth phase living polymers (H. Hsieh, R. Quirk, Anionic polymerization, Marcel Dekker, New York 1996).

It is known to link such living polymers with coupling agents to form polymers having a higher molar mass, block copolymers or star polymers. Many polyfunctional compounds such as polyfunctional silicon halides, tin halides, alkyl halides, aldehydes, anhydrides, carboxylic esters or diepoxides have been proposed as coupling agents.

The removal of protic contaminants from these compounds is often incomplete, which leads to low coupling yields. A lower coupling yield is observed especially in the presence of polar solvents. Aromatic compounds such as terephthalaldehyde or benzoic esters tend to produce yellowing in the polymers. Halogenated compounds give rise to halide residues in the polymers unless a technically difficult purification is carried out.

Some diepoxides, which are obtained by epoxidation of olefinic double bonds, are suspected to be carcinogenic, requiring extensive safety measures during use. EP A 0 643 094 and JP-A 03 285 978 disclose the use of diglycidyl ethers of phenols such as bisphenol A or bisphenol F as coupling agents. However, such diglycidyl ethers generally contain higher oligomers and α-glycols as admixtures. Owing to their low volatility and tendency to form oligomers at higher temperatures, they are difficult to purify.

Carboxylic esters give good coupling yields in apolar solvents, but unsatisfactory coupling yields in the presence of polar solvents such as tetrahydrofuran. However, such polar solvents are often added in anionic polymerization to control the microstructure, the copolymerization parameters or the polymerization rate and are therefore present during the coupling reaction.

For this reason, DE A 23 25 365 proposes using carboxylic esters having no hydrogen atom attached to the α-carbon atom. However, the proposed aromatic carboxylic esters exhibit the abovementioned yellowing.

It is an object of the present invention to remedy the abovementioned disadvantages and to provide a process for coupling living anionic polymers with a high coupling yield, especially in the presence of polar solvents. Moreover, the coupling agents used should not cause any deterioration in the properties of the polymers.

We have found that this object is achieved by a process for preparing polymers by coupling living polymer blocks formed from an anionic polymerization initiator and anionically polymerizable monomers using glycidyl ethers of aliphatic polyalcohols as coupling agents.

In principle, the process of the present invention can be applied to any anionically polymerizable monomers. Preference is given to vinylaromatic monomers and dienes.

Preferred vinylaromatic monomers are styrene and its derivatives substituted by 1 to 4 carbon atoms in α-position or at the aromatic ring, for example α-methylstyrene, p-methylstyrene, ethylstyrene, tert-butylstyrene and vinyltoluene; preference is further given to 1,1-diphenylethylene.

Suitable dienes are in principle all dienes having conjugated double bonds such as 1,3-butadiene, isoprene, 2,3-dimethylbutadiene, 1,3-pentadiene, 1,3-hexadienes, phenylbutadiene, piperylene or mixtures thereof. Butadiene and isoprene are particularly preferred.

The anionic polymerization is initiated by organometallic compounds. Initiators that can be used are the conventional alkali metal alkyls or aryls. It is advantageous to use organolithium compounds, such as ethyl-, propyl, isopropyl-, n-butyl-, sec-butyl-, tert-butyl-, phenyl-, hexyldiphenyl-, hexamethylenedi-, butadienyl-, isoprenyl-, polystyryllithium or 1,1-diphenylhexyllithium, which is easily obtainable by reacting 1,1-diphenylethylene with n- or sec-butyllithium. The amount of initiator required depends on the desired molecular weight for the uncoupled polymer blocks and is usually in the range from 0.002 to 5 mol % based on the amount of monomer to be polymerized.

Suitable solvents do not react with the organometallic initiator. It is convenient to use aliphatic, cycloaliphatic or aromatic hydrocarbons having 4 to 12 carbon atoms, such as cyclopentane, cyclohexane, methylcyclohexane, decalin, benzene, alkylbenzenes such as toluene, xylene or ethylbenzene or suitable mixtures.

Usable randomizers include, for example, Lewis bases, such as polar aprotic solvents or metal salts which are soluble in hydrocarbons. Usable Lewis bases include, for example, dimethyl ether, diethyl ether, ethylene glycol dimethyl ether, diethylene glycol dimethyl ether, tetrahydrofuran, tetrahydrofurfuryl ethers such as tetrahydrofurfuryl methyl ether or tertiary amines such as pyridine, tertiary amines such as trimethylamine, triethylamine, tributylamine or peralkylated bi- or oligoamines such as tetramethyl ethylenediamine. They are usually employed in concentrations of from 0.1 to 5 percent by volume based on the solvent. Preferred hydrocarbon soluble metal salts are alkali or earth alkaline metal salts of primary, secondary and preferably tertiary alcohols, particularly preferably the potassium salts such as potassium triethylcarbinolate or potassium tetrahydrolinalolate. The molar ratio of metal salt to initiator is usually from 1:200 to 1:5, preferably from 1:100 to 1:20.

The living polymer blocks are formed according to conventional anionic polymerization processes using the abovementioned monomers and initiators. Both homopolymer blocks or copolymer blocks of the abovementioned monomers can be formed. The copolymer blocks may be random or tapered. Living block copolymers having one or more identical or different homopolymer blocks or copolymer blocks can similarly be formed by sequential anionic polymerization.

Preference is given to using living polymer blocks prepared by sequential anionic polymerization of a vinylaromatic monomer block A and a subsequent diene block B. These blocks can be coupled to form symmetric triblock copolymers or star polymers having thermoplastic elastomeric properties.

The blocks A preferably have a molecular weight Mw of in general from 1000 to 500,000, preferably from 3000 to 100,000, particularly preferably from 4000 to 30,000.

The molecular weights Mw of the blocks B are in general in the range from 10,000 to 500,000, preferably from 20,000 to 350,000 and particularly preferably from 20,000 to 200,000. The glass transition temperatures of the blocks B are in general below −30° C., preferably below −50° C.

In accordance with the invention, the living polymer blocks are coupled by adding a glycidyl ether of an aliphatic polyalcohol. Preference is given to using low viscosity glycidyl ethers of short-chain aliphatic alcohols, especially of C₂-C₁₃-alcohols, which are also employed as reactive diluents for epoxy resins and do not carry free OH or NH groups. Examples are ethylene glycol diglycidyl ether, diethylene glycol diglycidyl ether, nonaethylene glycol diglycidyl ether, 1,2-propylene glycol diglycidyl ether, neopentyl glycol diglycidyl ether, 1,4-butanediol diglycidyl ether, 1,6-hexanediol diglycidyl ether, 1,2-bis(glycidoxymethyl)cyclohexane, bis(4-glycidyloxycyclohexyl)methane, glycerol triglycidyl ether, diglycerol triglycidyl ether, 1,1,1-trimethylolpropane triglycidyl ether, pentaerythritol tetraglycidyl ether, bisdiglycerol tetraglycidyl ether, trisdiglycerol pentaglycidyl ether. Particularly preferred coupling agents are 1,4-butanediol diglycidyl ether, ethylene glycol diglycidyl ether and trimethylolpropane triglycidyl ether.

The glycidyl ethers used have a purity of generally at least 95%, preferably at least 97%, very particularly preferably at least 99%. Commercially available technical grade diglycidyl ethers of aliphatic polyalcohols can be purified, for example, by fractional distillation under high vacuum. The purification is preferably carried out by gently evaporating the glycidyl ether in a thin film evaporator and distilling the vapor in packed columns at a reduced pressure of less than 1 mbar, preferably less than 0.1 mbar.

The amount of coupling agent used usually depends on the amount of living polymer ends, which generally corresponds to the amount of initiator employed. Usually, the stoichiometric amount or a small excess of, for example, from 10 to 50 mol % is used.

The coupling agent is conveniently added at from 30 to 70° C.

The coupling agent is added slowly to the solution of the living polymers to achieve a very high coupling yield. In a preferred embodiment of the process of the present invention, less than the stoichiometric amount, preferably from 70 to 90% of the stoichiometric amount, of the coupling agent, based on the anionic initiator used, is added to the living polymer blocks in a first stage. The balance of the stoichiometric amount and optionally an excess of the coupling agent is added after the reaction has taken place.

If the polymers prepared by coupling living polymer blocks also contain diene blocks, the diene block B can be completely or partially hydrogenated after the coupling reaction. The hydrogenation of polyisoprene blocks accordingly yields ethylene-propylene blocks and the hydrogenation polybutadiene blocks yields polyethylene or polyethylene-butylene blocks, respectively, corresponding to the 1,2-vinyl proportion of the nonhydrogenated butadiene block. The hydrogenation provides block copolymers which are thermally more stable and especially more resistant to aging and weathering.

The work-up is carried out by conventional methods of polymer technology, for example by degassing in extruders, precipitating with polar solvents such as alcohols or dispersing in water and stripping off the solvent.

The process of the present invention provides very high coupling yields, especially in the presence of polar compounds such as tetrahydrofuran. It is therefore especially suitable for preparing symmetric triblock copolymers and star polymers which are used as thermoplastic elastomers.

The polymers prepared according to the process of the present invention can be processed as such or in admixture with further polymers and with additives and processing aids in conventional amounts to form molding compositions. Examples are fibrous and pulverulent fillers and reinforcing agents, stabilizers, flame retardants, pigments, dyes and processing aids such as lubricants, mold release agents or white oil.

### EXAMPLES

### Purification of 1,1-diphenylethylene (DPE)

Commercially available DPE was distilled to a purity of 99.8% through a column having at least 50 theoretical plates (spinning band column; for larger amounts, a column with Sulzer packing). The usually slightly yellow distillate is filtered through a 20 cm alumina column (Woelm, chromatographic grade, anhydrous), titrated with 1.5 N sec-butyllithium until a deep red color appears and vacuum distilled (1 mbar). The resulting product is completely colorless and can be employed directly in an anionic polymerization.

### Purification of Monomers and Solvent

The cyclohexane solvent was dried over anhydrous aluminum oxide and titrated with the adduct of sec-butyllithium and 1,1-diphenylethylene until a yellow color appeared. The 1,1-diphenylethylene (DPE) was separated from sec-butyllithium (s-BuLi) by distillation. The initiator used was a 0.5 molar solution of s-BuLi in cyclohexane. Styrene (S) and butadiene were dried over aluminum oxide at −10° C. immediately before use.

### Purification of 1,4-butanediol Diglycidyl Ether

475 g of technical grade 1,4-butanediol diglycidyl ether (Grilonit® RV 1806) were fractionally distilled in a distillation apparatus comprising a two-necked 2 l glass flask, a 60 cm column packed with Raschig rings and a NORMAG 8011 distillation head at a pressure of less than 0.1 mbar. The Examples which follow were carried out using the mixed fractions distilled at a distillation head temperature from 84 to 87° C., unless otherwise indicated (see Table 1).

TABLE 1
Fractional distillation of 1,4-butanediol diglycidyl ether

| | Temperature | | | | | | |
|---|---|---|---|---|---|---|---|
| Time | Bath | Bottom | Head | Pressure | | | Purity |
| [min] | [° C.] | [° C.] | [° C.] | [mbar] | Note | Yield | [GC] |
| 34 | 145 | 141 | 69.8 | 0.08 | Fraction 1 | 35.32 g | 2.10% |
| 53 | 154 | 144 | 71.3 | 0.07 | Fraction 2 | 26.59 g | 3.83% |
| 102 | 172 | 152 | 71.6 | 0.07 | Fraction 3 | 52.23 g | 12.56% |
| 135 | 171 | 155 | 83.4 | 0.06 | Fraction 4 | 30.27 g | 65.76% |
| 219 | 177 | 158 | 87.2 | 0.05 | Fraction 5 | 96.91 g | 96.77% |
| 301 | 180 | 162 | 87.1 | 0.05 | Fraction 6 | 105.10 g | 99.34% |
| 347 | 181 | 164 | 85.3 | 0.07 | Fraction 7 | 97.24 g | 99.18% |
| 423 | 185 | 168 | 84.2 | 0.06 | Fraction 8 | 26.62 g | 99.53% |

The molecular weights were measured by gel permeation chromatography in THF using polystyrene standards obtained from Polymer Laboratories and refractometric detection.

The coupling yield was determined from the GPC distribution (gel permeation chromatography) in the form of the ratio of coupled products to the sum of coupled products and uncoupled polymers to assess the efficiency of the coupling step.

The double bond content was determined by titration according to the method of Wijs (iodometry).

The mechanical properties were determined as a function of temperature on standard small bars in the tensile test according to DIN 53 455.

### Example 1

5,439 ml of cyclohexane containing 1 ml of 1,1-diphenylethene as an indicator were titrated at 60° C. until a yellow color appeared and 16.7 ml (25 mmol) of s-butyllithium (1.5 molar solution in cyclohexane) and 14.7 ml of tetrahydrofuran were added. 750 g (13.86 mol) of 1,3-butadiene were added all at once. The reaction solution was maintained at from 45 to 50° C. at an internal vessel pressure of 12 bar until the reaction had ceased. After 20 minutes postreaction time, the pressure was slowly reduced to 0.3 bar and 1.93 ml (10 mmol) of 1,4-butanediol diglycidyl ether (98.5%) were added dropwise at 50° C. 5 minutes after addition was completed, another 0.48 ml (2.5 mmol) of 1,4-butanediol diglycidyl ether was added. The molar mass Mw was 28,620 g/mol before coupling and 55,450 g/mol after coupling. The coupling yield was 93.4%.

### Comparative Runs V1 to V6

The procedure of Example 1 was repeated, except that the coupling agents of Table 2 were added in stoichiometric amounts at 50° C. Table 2 also summarizes the coupling yields. The coupling agents were freed from protic contaminants prior to use and had a purity of more than 98%.

TABLE 2
Coupling yields of various coupling agents in the presence of
0.27 vol % tetrahydrofuran, based on the solvent.

| Example | Coupling agent | Coupling yield [%] |
|---|---|---|
| Example 1 | 1,4-Butanediol diglycidyl ether | 93.4 |
| V1 | 1,2-Dibromoethane | 78 |
| V2 | Ethyl formate | 19 |
| V3 | Ethyl acetate | 64 |
| V4 | Octadiene diepoxide | 92.2 |
| V5 | Butadiene diepoxide | 67.6 |
| V6 | 4-Vinyl-1-cyclohexene diepoxide | 50.7 |

### Example 2

1.5 kg of cyclohexane, 1.67 kg of 1,1-diphenylethylene and 300 ml of a 1 molar solution of s-butyllithium in n-hexane were charged into a 50 l reactor and stirred at 50° C. for 14 h. Then 1.21 kg of styrene were added at 1 kg/h, maintaining the temperature at 50° C. 30 minutes after styrene addition had been completed, the reaction mixture was diluted with 19.5 kg of cyclohexane and cooled to 40° C. The resulting S/DPE copolymer block had a molecular weight Mn of 3754 g/mol, M_{w} of 4445 g/mol, Mp of 4676 g/mol, M_{w}/Mₙ=1.18, and a glass transition temperature of 152° C. 70 ml of freshly titrated tetrahydrofuran were added to the polymer solution. Subsequently, first 2.04 kg of butadiene at 8 kg/h and then 4.08 kg at 3 kg/h were metered in. After a further 20 minutes at 40° C., 35 ml of 1,4-butanediol diglycidyl ether were added. The resulting block copolymer had a molecular weight M_{w} of 58,180 g/mol, and the coupling yield was 88%. The viscosity number (0.5% in toluene) was 55. The double bond content according to Wijs was measured to be 52.4%. The 1,2-vinyl content was 43.2%.

### Example 3

1.5 kg of cyclohexane, 1.12 kg of 1,1-diphenylethylene and 57.1 ml of a 1 molar solution of s-butyllithium in n-hexane were charged into a 50 l reactor and stirred at 50° C. for 14 h. Then 0.8 kg of styrene was added at 1 kg/h, maintaining the temperature at 50° C. 30 minutes after styrene addition had been completed, the reaction mixture was diluted with 22.5 kg of cyclohexane and cooled to 40° C. The resulting S/DPE copolymer block had a molecular weight Mₙ of 9450 g/mol, M_{w} of 10,420 g/mol, Mp of 10,220 g/mol, M_{w}/Mₙ=1.10. 70 ml of freshly titrated tetrahydrofuran were added to the polymer solution. Subsequently, first 1.36 kg of butadiene at 8 kg/h and then 2.72 kg at 3 kg/h were metered in. After a further 20 minutes at 50° C., 8.3 ml of 1,4-butanediol diglycidyl ether were added. The resulting block copolymer had a molecular weight M_{w} of 213,500 g/mol and the coupling yield was 85%. The viscosity number (0.5% in toluene) was 55. The double bond content according to Wijs was measured to be 59.7%. The 1,2-vinyl content was 42.6%.

### Example 4

24 kg of cyclohexane, 70 ml of tetrahydrofuran, 1.92 kg of styrene and 5 ml of 1,1-diphenylethylene were titrated dropwise at 40° C. in a 50 l reactor with a 1 molar solution of s-butyllithium in n-hexane until a yellow color appeared. Immediately thereafter, 36 ml of a 1 molar solution of s-butyllithium in n-hexane were added and the reaction mixture was stirred at 70° C. for 2 h. The resulting polystyrene block had a molecular weight Mw of 29,000 g/mol. Subsequently, 4.08 kg of butadiene were first metered in at 3 kg/h. After a further 20 minutes at 50° C., 7.2 g of 1,4-butanediol diglycidyl ether were added. The resulting block copolymer had a molecular weight Mw of 270,000 (compared to polystyrene standard) and the coupling yield was 93%. Mw was 182,000 as measured by light scattering. The double bond content (incorporated butadiene) according to Wijs was 67.8%. The 1,2-vinyl content based on total butadiene was 41.3%.

### Example 5

24 kg of cyclohexane, 70 ml of tetrahydrofuran, 1.74 kg of styrene and 5 ml of 1,1-diphenylethylene were titrated dropwise at 40° C. in a 50 l reactor with a 1 molar solution of s-butyllithium in n-hexane until a yellow color appeared. Immediately thereafter, 220 ml of a 1 molar solution of s-butyllithium in n-hexane were added and the reaction mixture was stirred at 70° C. for 2 h. The resulting styrene block had a molecular weight M_{w} of 8100 g/mol. Subsequently, 4.26 kg of butadiene were metered in at 3 kg/h at 50° C. After a further 20 minutes at 50° C., 22.2 g of 1,4-butanediol diglycidyl ether (98.5%) were added. The resulting block copolymer had a molecular weight M_{w} of 77,000 (compared to polystyrene standard) and the coupling yield was 95%. The double bond content (incorporated butadiene) according to Wijs was 70.8%. The 1,2-vinyl content based on total butadiene was 40.5%.

### Example 6

Example 5 was repeated, except that the 1,4-butanediol diglycidyl ether used for coupling had a purity of 99.5% (fraction 9). The coupling yield was 97%.

### Preparation of Hydrogenated Triblock Copolymers

### Example 7

### Preparation of Hydrogenation Catalyst

1125 ml of a room temperature saturated solution of nickel acetylacetonate in toluene (about 10 g/l) were added with stirring to a solution of 192.5 ml of a 20% by weight solution of triisobutylaluminum in n-hexane under nitrogen in a round-bottom flask. During the slightly exothermic reaction, isobutanol evolved and the temperature rose to 50° C.

The polymer solution of Example 2 was heated to 60° C. in a stirred 50 l reactor and a freshly prepared catalyst suspension was added. Hydrogenation was then carried out at 120° C. and under a pressure of 18 bar using hydrogen. After 25 h a residual double bond content of 22.6% was found. After a further 17.5 h the solution was cooled to 60° C. The double bond content was 18.5%.

Then the reaction solution was subjected to an oxidative treatment using 300 ml of a mixture of 3.6 l of water, 360 ml of a 30% strength hydrogen peroxide solution and 200 ml of 98% strength acetic acid at 60° C. and this residue was washed with water and dried.

The hydrogenated S/DPE-Bu-S/DPE block copolymer was stabilized by adding 0.1% by weight of both Irganox® 3052 and Kerobit® TBK.

The viscisity number (0.5% in toluene) was 51 ml/g.

The mechanical properties were determined on standard small bars (stamped out of pressed sheets) at 23° C. Tensile strength: 25 MPa; ultimate elongation: 1014%; Shore hardness A: 69.

### Example 8

The polymer solution of Example 3 was hydrogenated as described in Example 7. The double bond content was 2.6%; Shore hardness A: 54.7.

### Example 9

The polymer solution of Example 4 was hydrogenated, oxidized, washed and dried as described in Example 7. The residual double bond content according to Wijs was 2.2%; Shore hardness A: 75.

### Example 10

The polymer solution of Example 5 was hydrogenated, oxidized, washed and dried as described in Example 7. The residual double bond content according to Wijs was 1.4%. The tensile test gave an ultimate elongation of 550% at a yield stress of 35 MPa; Shore hardness A: 74.

We claim:

1. A process for preparing polymers by coupling living polymer blocks formed from an anionic polymerization initiator and anionically polymerizable monomers, which comprises using glycidyl ethers of aliphatic polyalcohols having a purity of at least 95% as coupling agents.

2. A process for preparing polymers as claimed in claim 1, wherein the glycidyl ether used is ethylene glycol diglycidyl ether, 1,4-butanediol diglycidyl ether or trimethylolpropane triglycidyl ether.

3. A process for preparing polymers as claimed in claim 1 or 2, wherein the coupling agent is added in at least two stages, adding less than the stoichiometric amount of coupling agent based on the anionic initiator in the first stage and allowing the reaction to proceed.

4. A process for preparing polymers as claimed in any of claims 1 to 3, wherein the anionic polymerization initiator used is an organolithium compound.

5. A process for preparing polymers as claimed in any of claims 1 to 4, wherein the anionically polymerizable monomers used are vinylaromatic monomers and dienes.

6. A process for preparing block copolymers as claimed in any of claims 1 to 5, wherein the living polymer blocks used are lithium-terminated diblock copolymers of vinylaromatic monomers and dienes.

7. Polymers obtainable by a process as claimed in any of claims 1 to 6.

8. Use of the polymers as claimed in claim 7 in thermoplastic molding compositions.
